(19) United States
(12) Patent Application Publication
(10) Pub. No.: US 2017/0097026 A1
(43) Pub. Date: Apr. 6, 2017

(54) Component Connection

(71) Applicant: Bayerische Motoren Werke Aktiengesellschaft, Muenchen (DE)

(72) Inventor: Franz KORBER, Mallersdorf (DE)

(21) Appl. No.: 15/381,207

(22) Filed: Dec. 16, 2016

Related U.S. Application Data
(63) Continuation of application No. PCT/EP2015/063083, filed on Jun. 11, 2015.

(30) Foreign Application Priority Data
Jun. 18, 2014 (DE) 10 2014 211 650.3

(51) Int. Cl. F16B 5/06; F16B 21/06

(52) U.S. Cl. CPC F16B 5/0657; F16B 5/0642; F16B 5/0664; F16B 21/065

(57) ABSTRACT

A component connection has a first component, a male fixing element which is formed by at least one sphere and which is connected to the first component at a connecting point of the first component and which projects from the first component, and a clip element, which is clipped onto the male fixing element in such a way that the clip element bears obliquely from below on the outside of the at least one sphere in a region between an upwardly pointing top of the first component and an equatorial plane of the at least one sphere. The connecting point at which the male fixing element is connected to the first component is an elevation, in particular an outward pressing, or a depression, in particular an inward pressing, of the first component.

### CROSS REFERENCE TO RELATED APPLICATIONS

This application is a continuation of PCT International Application No. PCT/EP2015/063083, filed Jun. 11, 2015, which claims priority under 35 U.S.C. §119 from German Patent Application No. 10 2014 211 650.3, filed Jun. 18, 2014, the entire disclosures of which are herein expressly incorporated by reference.

### BACKGROUND AND SUMMARY OF THE INVENTION

The present invention relates to a component connection having a first component, a male fixing element formed by at least one sphere and connected to the first component at a connecting point of the first component and projecting from the first component, and a clip element clipped onto the male fixing element in such a fashion that the clip element bears on the at least one sphere.

A component connection of this type is known from U.S. Pat. No. 2,275,900 A. The technical background of the invention includes DE 10 2011 018 525 A1; U.S. Pat. No. 2,266,049 A; DE 10 2011 053 786 A1; DE 36 00 311 A1; DE 34 41 349 A1 as well as the older DE 10 2013 218 650.9, which was not previously published.

DE 10 2013 218 650.9 proposes a component connection comprising a first component and a male fixing element projecting therefrom, onto which a claw-like clip element is clipped. The male fixing element is formed by two spheres welded to each other, with “the lower sphere” being clipped onto the first component. With the clip element, a second component, which is placed onto the first component and has a hole through which the male fixing element extends, can be fixedly clipped to the first component.

For the stability of such a clip connection, it is extremely important that the “height” of the male fixing element, that is to say, the diameter of the spheres of the male fixing element and the thickness of the second component, are geared to each other such that radial inner ends of tongue-like clamping elements of the clip element bear from the outside on the male fixing element in a region below the equatorial plane of the “upper sphere” of the male fixing element.

The object of the invention is to provide a component connection where a male fixing element with a specified “sphere diameter” is suitable for a multitude of possible applications.

This and other objects of the invention are achieved in accordance with embodiments of the invention.

The starting point of the invention is a component connection comprising a first component and a male fixing element projecting therefrom. The first component can be a metal component, for example, in particular a sheet metal component or a plastic component, in particular a fiber-reinforced plastic component.

The male fixing element has at least one sphere (used herein to also reference at least one spherical or spherical-like section), which is connected to the first component at a connecting point of the first component and projects therefrom. In particular, the male fixing element can be formed by a so-called “double sphere”, that is to say, by two directly interconnected spheres or two directly interconnected spherical or spherical-like sections, of which the “lower spherical section” or “the lower sphere” is connected to the first component.

Clipped onto the male fixing element is a clip element, which, for example, can be configured as a fastening claw according to the type described in DE 10 2013 218 650.9 mentioned earlier. Such a clip element bears obliquely from below on the outside of the at least one sphere or the at least one spherical or spherical-like section in a region between an upper side of the first component and an equatorial plane of the at least one sphere or the at least one spherical or spherical-like section.

In accordance with the invention, the connecting point at which the male fixing element is connected to the first component is developed as a local elevation or as a local depression. Due to the “height” of the local elevation or local depression, it is possible to adjust how far the male fixing element projects from the first component (relative to a level located radially slightly “outside” of the local elevation or local depression) when using a specified “sphere diameter.”

As far as the first component consists of a ductile material, such as steel or aluminum, for example, the local elevation can be developed as an “outward pressing” or the local depression can be developed as an “inward pressing” of the first component. The local elevation or the local depression can also be created by locally forming the first component. For example, if the first component is a sheet metal component formed by deep drawing, the local elevation or the local depression can be created during the pressing or deep drawing process in the pressing or deep drawing tool. In as far as the first component is a plastic component, such as, for example, an injection molding component, the local elevation or depression can be created directly during the forming, that is to say, in the forming tool.

According to an aspect of the invention, it is provided that the at least one sphere or the at least one spherical or spherical-like section of the male fixing element bears directly on the connecting point or is connected to the first component directly at the connecting point. The male fixing element is firmly bonded, for example, to the connecting point of the first component, in particular welded to it.

Alternately, it may also be provided that at least one sphere or at least one spherical or spherical-like section of the male fixing element is pressed into the material (for example, into the elevation or depression) of the first component and therefore into the first component. This is done in such a fashion that the at least one sphere or the at least one spherical or spherical-like section of the male fixing element is connected to the first component in a form-fitted manner. The at least one sphere or the at least one spherical or spherical-like section of the male fixing element does not have to be completely pressed into the first component, but can also be pressed in only partially, that is to say, a part of the second sphere or the second spherical or spherical-like element that is not pressed in may project from the first component after the pressing in.

Pressing the at least one sphere or the at least one spherical or spherical-like element into the first component results in a flow of the material of the first component and/or the material of the second sphere or the second spherical or spherical-like element, such that the aforementioned form fit results between the sphere or the spherical or spherical-like element and the first component. “Pressing in” therefore means that material of the first component and/or the sphere or the spherical or spherical-like element flows rather than, for example, the sphere being clamped into a recess of the first component.

According to a further aspect of the invention, it is provided that the material of the sphere or the spherical or spherical-like element or the material of the complete connecting element is harder or at least as hard as the material of the first component.

Experiments have shown that a connecting element according to the invention can be pressed into a first component in such a manner that the material of the first component flows in such a fashion that it encompasses the sphere or the second spherical or spherical-like element of the connecting element at least partially in a form-fit, similar as is the case with the joint socket of a ball joint.

Preferably, a sphere or a spherical or spherical-like element of the male fixing element is pressed into the first component in such a fashion that the material of the first component extends up to a region above the equatorial plane of the sphere or the spherical or spherical-like element of the fixing element and is adapted closely to the sphere or the spherical or spherical-like element of the fixing element. Preferably, the material of the first component is adapted to a sphere or a spherical or spherical-like element of the fixing element over a complete circumference of the sphere or the spherical or spherical-like element of the fixing element.

In this way, a form-fitting and essentially inseparable connection is achieved between the sphere or the spherical or spherical-like element and the first component.

According to a further aspect of the invention, the sphere or the spherical or spherical-like element is pressed into the first component in such a fashion that it does not intersperse the first component. It may be provided that the first component is bulged in the region of the sphere or the spherical or spherical-like element at the side facing away from the component.

Experiments have shown that pressing in the sphere or the spherical or spherical-like element of the connecting element not only allows achieving a highly stable, but also high-quality, tear-free connection between the sphere or the spherical or spherical-like element and the first component, which in terms of its production quality is comparable to a high-quality produced and reworked welded connection.

As already mentioned, the male fixing element can be developed by two or more interconnected spheres or spherical sections (double sphere or multiple spheres).

The individual spheres or spherical or spherical-like sections can be arranged in one line back to back like a string of pearls, for example. However, it can also be provided that one or a plurality of spheres or spherical or spherical-like sections projects from one or a plurality of other sphere(s) or spherical or spherical-like sections.

It may be provided that the clip element has a greater radial width than the local elevation or local depression that forms the connecting point. This means that the clip element then projects in radial direction over the local elevation or local depression.

With this type of clip element, a second component can be clipped to the first component. It may be provided that the second component has a hole through which the male fixing element projecting from the first component extends. The clip element clipped onto the male fixing element is supported on the one hand from below on the outside at the male fixing element or at a sphere or a spherical section of the male fixing element, and on the other hand at a top side of the second component which faces away from the first component, which causes the second component to be pressed against the first component. Preferably, the clip element extends radially to the outside far enough that it reaches into the through-hole provided in the second component.

It may be provided that a transition region between the local elevation or the local depression and a region located radially outside the local elevation or local depression of the first component is developed conically. A conical development of the transition region is of advantage in particular with a local elevation because a conical development of the transition region reduces the risk of a canting of the second component during placement on the first component. The through-hole provided in the second component can slide at the conical transition region from the local elevation downward until it bears on the top side of the first component. Furthermore, it can be provided that the transition region and/or the male fixing element on the one hand, and the through-hole provided in the second component on the other hand, form a “type of fit.” This leads to a form fit between the second component and the elevation or the male fixing element, which fixes the two components in transverse direction relative to one another.

In particular, the invention can be used in connection with a “claw-like fastening element” (also referred to as “fastening claw” in the following). Such a claw-like fastening element has an annulus section, from the radial inner side of which at least two, preferably three or four flexible, tongue-like elements project obliquely inward at the top in the direction of a top side of the fastening claw.

The tongue-like elements have free ends. The free ends of the tongue-like elements border or define a center open region of the fastening claw. From a lower side of the fastening claw, a fixing element can be introduced and inserted between the free ends of the tongue-like elements. The fixing element can be a fixing element having a spherical or sphere-like head. However, in principle, other designs of fixing elements are contemplated as well, which can be introduced into the center open region of the fastening claw.

The tongue-like elements mentioned earlier are separated by slots that extend from a region near the annulus section essentially radially inward. It may be provided that radial outer ends of the slots provided between the tongue-like elements are rounded out.

Furthermore, it may be provided that the tongue-like elements taper towards their free ends. The free ends of the tongue-like elements can be developed convexly rounded off, for example. Alternately, the free ends of the tongue-like elements can also be developed straight in such a fashion that they extend “tangentially” relative to the center open region of the fastening claw. Alternately, it may be provided that the free ends of the tongue-like elements are developed concavely. A concave design of the free ends of the tongue-like elements has the advantage that they, as far as the fixing element clamped between them is developed round, can adapt to its outer contour.

According to a further aspect of the invention, the tongue-like elements project obliquely from the annulus section. “Obliquely” means that each of the tongue-like elements encloses a certain angle with the plane formed by the annulus section. Experiments have shown that it is advantageous if said angle is in a range of 10° to 40°. Especially advantageous are angles in a range of 20° to 30°. In a specific exemplary embodiment, for example, it may be provided that the angle enclosed by the tongue-like elements with the annulus section, is 28° or more.

According to a refinement of the invention, the tongue-like elements are arranged evenly distributed in circumferential direction of the annulus section. In particular, they may be designed identically. As already mentioned earlier, at least two tongue-like elements are provided. Under stability aspects, it is favorable if exactly three or exactly four tongue-like elements are provided. In principle, however, it is also possible to provide five or more such tongue-like elements.

The fastening claw can be made of metal, in particular of sheet metal. For example, it can be punched from steel sheet metal, with the tongue-like elements being bent open as described earlier.

According to a further aspect of the invention, a plurality of “screen ring sections”, which are arranged in circumferential direction of the annulus section, project from the annulus section radially outward. In the circumferential direction, two each back to back screen ring sections are separated by a screen ring slot extending in a radial direction. The screen ring sections provide the fastening claw with additional elasticity. The screen ring sections have a similar function as leaf springs or disk springs, which is to say, in the mounted state, they press the fastening claw against a component.

Radial inner ends of the screen ring slots can be rounded out.

According to a further aspect of the invention, it is provided that the screen ring slots are offset in the circumferential direction relative to the slots provided between the tongue-like elements.

Preferably, the screen ring sections project obliquely downward from the annulus section, which results in a “hat-like form” of the fastening claw.

It may be provided that the number of screen ring sections is equal to or greater than the number of the tongue-like elements.

In as far as the fastening claw is made of steel, it is advantageous that it is case-hardened. Furthermore, it may be provided that the fastening claw is coated with a coating material, such as, for example, with an anticorrosive coating and/or with an electrically insulating coating.

Alternately to metal, the fastening claw can also be made of plastic, for example. What is important is that the fastening claw has a certain minimum elasticity.

According to a further aspect of the invention, it is provided that the fastening claw is a separate connecting element and not an integral component of another component or another part. However, the latter is also definitely not ruled out. It goes without saying that the fastening claw can also be an integral component of another component or another part, or it can be connected to another component or another part.

A further aspect of the invention is a component connection with a fastening claw as the one described above. Such a component connection has a (first) component with a male fixing element projecting from the first component. The male fixing element can be broken down into a first section and into a second section, which is connected to the first section or follows the first section. Via the first section, the male fixing element is connected directly to the first component. The male fixing element can be connected to the first component via the first section, for example in one piece, or it can be welded to the first component or connected to the first component in another way. According to the invention, the second section, which connects to the first section, has the form of a sphere or a sphere-like form.

The first section can also have the form of a sphere or a sphere-like form. In that case, the male fixing element is formed by two connected spheres or spherical elements (so-called “double sphere”), which are welded together, for example.

However, this does not necessarily have to be the case. The first section could also be formed like a peg or a cylinder or the like, for example. The second spherical or spherical-shaped section preferably projects like a head from the first section.

The fastening claw is clipped onto the male fixing element, in particular on its spherical or sphere-like second section, in such a fashion that the free ends of the tongue-like elements bear obliquely from below on the spherical or sphere-like section in a region between a top side of the first component and an equatorial plane of the spherical or sphere-like section. Because of said bearing position below the equatorial plane, a form fit or an undercut is obtained, which means that in principle, the fastening claw can be pulled off the male fixing element only by destroying the fastening claw or by way of a suitably designed special tool.

According to a further aspect of the invention, it is provided that the component connection has a second component, which in turn has a through-hole through which the male fixing element extends.

It may be provided that at least the annulus section and/or the screen ring sections bear on the second component in a region of the second component that is near the through-hole (spring-like) at a second side of the second component facing away from the first component. The annulus section and/or the screen ring sections therefore resist a pulling off of the second component from the first component. Because of the form of the fastening claw, a pull-off force acting on the second component is transformed into forces that act in the longitudinal direction of the tongue-like elements and which are supported at the free ends of the tongue-like elements by the second, spherical or sphere-like section of the male fixing element. This results in a self-restraint that counteracts the pull-off force.

The component connection according to the invention can be used in a variety of technology fields. Various applications are contemplated, for example, in automotive engineering, in particular in automotive body construction. Accordingly, the first and/or the second component can be a first or second automotive body part, for example.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic representation illustrating the basic principle of a claw-like fastening element according to an embodiment of the invention.

FIG. 2 illustrates the significance of the oblique angle of the tongue-like elements.

FIG. 3 illustrates a second component with a through-hole through which a double sphere projects.

FIG. 4 illustrates the exemplary embodiment of FIG. 3 with a clipped on fastening claw.

FIG. 5 is an enlarged representation of a component connection according to an embodiment of the invention.

FIG. 6 is an alternate exemplary embodiment of a fastening claw with two spring elements.

FIG. 7 illustrates a fastening claw with four spring elements.

FIG. 8 is an alternately designed fastening claw with four spring elements.

FIG. 9 is a further alternative of a fastening claw with four spring elements.

FIG. 10 illustrates a fastening claw with additional screen ring sections.

FIG. 11 is a variant of the exemplary embodiment of FIG. 10.

FIG. 12 is another variant of a fastening claw.

FIG. 13 is an exemplary embodiment of a component connection according to the invention.

FIG. 14 is another exemplary embodiment according to the invention with a thicker second component.

FIG. 15 is an exemplary embodiment of a component connection where the connecting point is developed as a local depression.

### DETAILED DESCRIPTION OF THE DRAWINGS

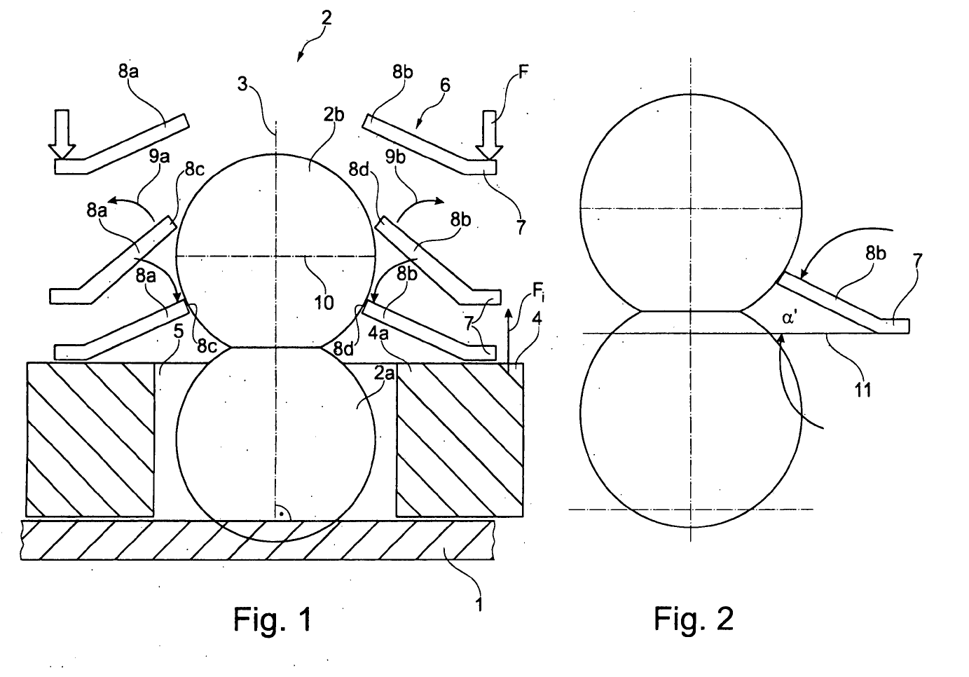

It should be noted in advance that all technical features shown in FIGS. 1 to 15 are an object of the present invention, even if the elevation and/or depression according to the invention is not explicitly shown in FIG. 1.

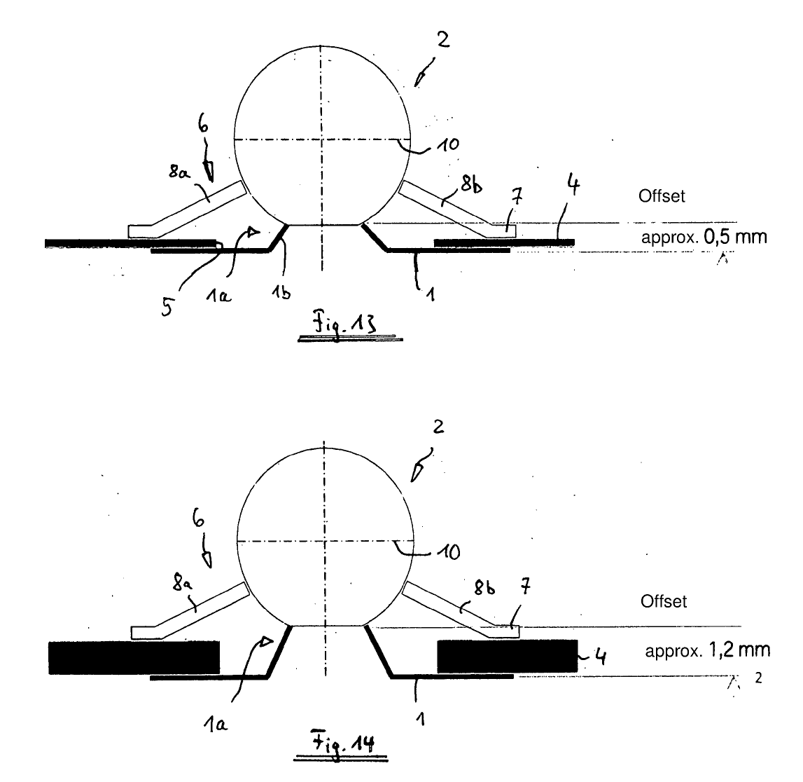

FIG. 1 shows a schematic representation of a component connection with the elevation or depression according to the invention not being explicitly shown (see also FIGS. 13 to 15). Onto a first component 1, which may be, for example, a (steel) sheet metal (such as a body part of an auto body), a “male fixing element” 2 is welded. The male fixing element 2 is formed here by two spheres 2a, 2b, which are welded together. The sphere 2a is welded onto the top side of the component 1. A straight line 3 running through the two center points of the spheres 2a, 2b is perpendicular to the surface of the component 1 at the contact point of the sphere 2a.

Alternately, it may also be provided that the sphere 2a is pressed into the material of the first component 1 at least far enough that a form-fitting connection between the sphere 2a and the first component 1 is obtained. The pressing in can occur in a pressing or deep drawing tool, in which or by means of which the first component is formed. The pressing in of a sphere, or a sphere of a “double sphere”, is an alternate fastening option that exists not only with the exemplary embodiment shown in FIG. 1 but also with all other exemplary embodiments as well.

A second component 4 is placed on the first component 1. The second component 4 has a through-hole 5, the diameter of which is greater than the diameter of the two spheres 2a, 2b of the male fixing element 2. The male fixing element 2 projects through the through-hole 5, with the sphere 2b being located completely on the top side 4a of the second component 4, which faces away from the component 1.

The two components 1, 4 are clamped together by way of the male fixing element, which is developed here as a “double sphere,” and a fastening claw 6. The fastening claw 6, which is only schematically represented in FIG. 1, has an essentially planar annulus section 7 as well as two flexible, tongue-like elements 8a, 8b.

In FIG. 1, the fastening claw 6 is shown in three different positions, that is to say—starting from the top—in an initial position, in a center position, and then in a joined position.

Proceeding from the initial position, the fastening claw 6 is pressed onto the sphere 2b with a force F, which causes the tongue-like elements 8a, 8b to bend elastically upward, as shown by arrows 9a, 9b. Free ends 8c, 8d of the tongue-like elements 8a, 8b slide downward at the outer circumference of the sphere 2b via its equatorial plane 10.

When the fastening claw 6 and its annulus section 7 bear on the top side 4a of the second component 4, the tongue-like elements 8a, 8b project obliquely upward from the annulus section 7, with the free ends 8c, 8d of the tongue-like elements 8a, 8b bearing on the outer circumference of the sphere 2b obliquely from below in a region between the top side 4a of the second component 4 and the equatorial plane 10 of the sphere 2b. This results in a form fit.

A pulling off of the second component 4 from the first component, which is indicated by the force F₁, is blocked by the fastening claw 6. The pulling off force F₁ is transferred over the annulus section 7 to the fastening claw and is introduced into the sphere 2b of the male fixing element 2 and supported by the same via the tongue-like elements 8a, 8b in the longitudinal direction of the tongue-like elements 8a, 8b and/or via their free ends 8c, 8d. Because the tongue-like elements 8a, 8b do not bend upward on their own, a pulling off of the second component 4 from the first component 1 is prevented.

Experiments have shown that it is favorable if, as shown in FIG. 2, the angle a between the plane 11 formed by the annulus section 7 and the tongue-like elements (only the tongue-like element 8b is shown in FIG. 2) is in a range of 10° to 40°, preferably in a range of 20° to 30°. In the exemplary embodiment shown in FIG. 2, the angle a is approx. 25°.

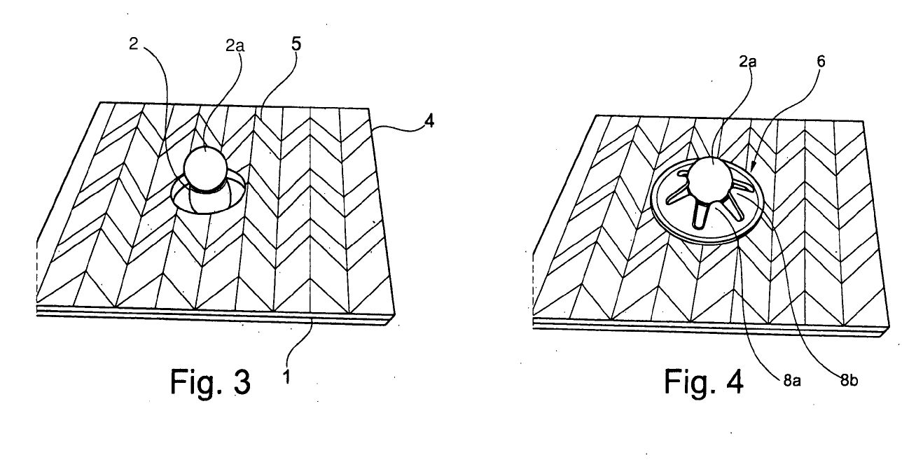

FIG. 3 shows a part of the arrangement according to the invention, wherein a component 4, which has a hole 5, is placed on a component 1 in such a manner that a “double sphere” (corresponds to the male fixing element 2) projecting from the component 1 projects with its upper sphere 2a through the hole 5.

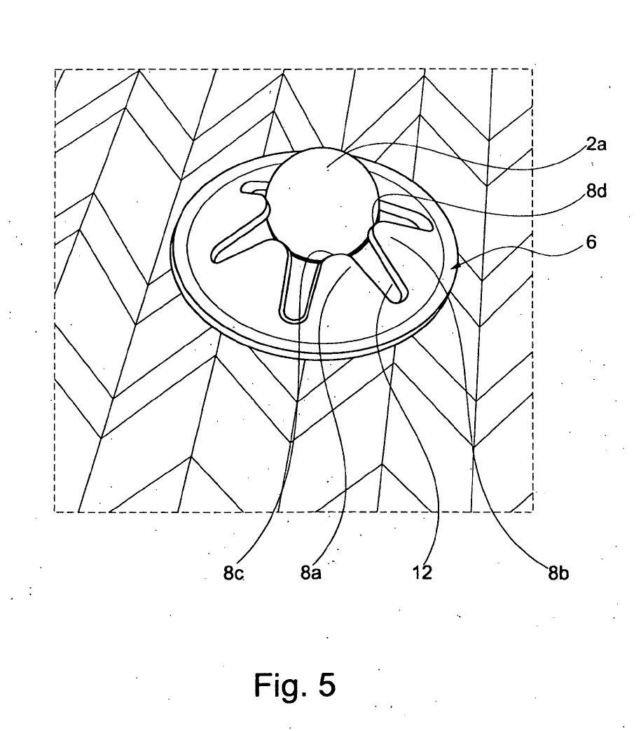

FIG. 4 shows the “finished” component connection, wherein a fastening claw 6 is clipped onto the sphere 2a; said fastening claw has a plurality of tongue-like elements 8a, 8b which are distributed in circumferential direction.

FIG. 5 shows an enlarged representation of such a component connection. It is clearly visible that the tongue-like elements 8a, 8b taper towards their free ends 8c, 8d. The individual tongue-like elements 8a, 8b are each separated from one another by slots 12 extending radially inward. As shown in FIG. 5, radial outer ends of the slots 12 provided between the tongue-like elements 8a, 8b are rounded out.

In the exemplary embodiment shown in FIG. 5, the free ends 8c, 8d of the tongue-like elements 8a, 8b are essentially developed straight, that is to say, they bear tangentially on the sphere 2a. Alternately, the free ends could also be developed convexly rounded or concavely rounded. Concavely rounded free ends have the advantage that they would closely adapt to the outer circumference of the sphere 2a.

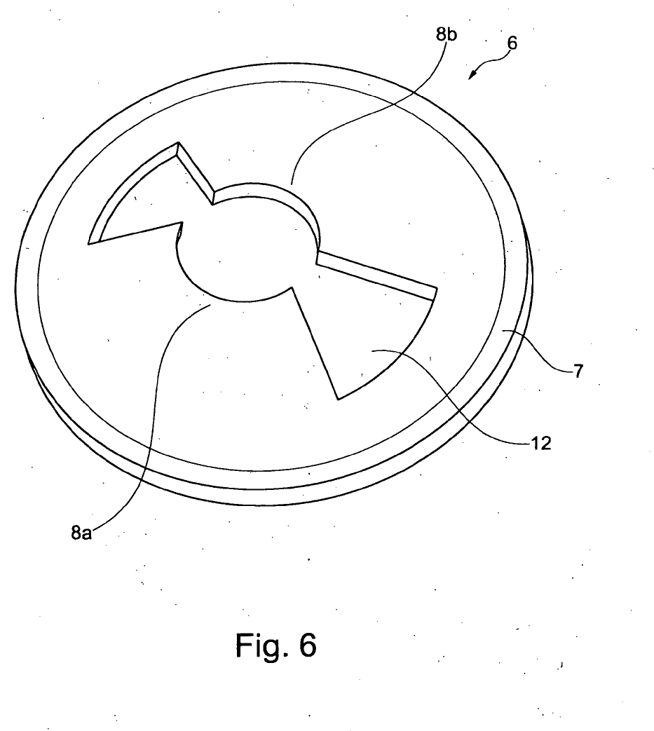

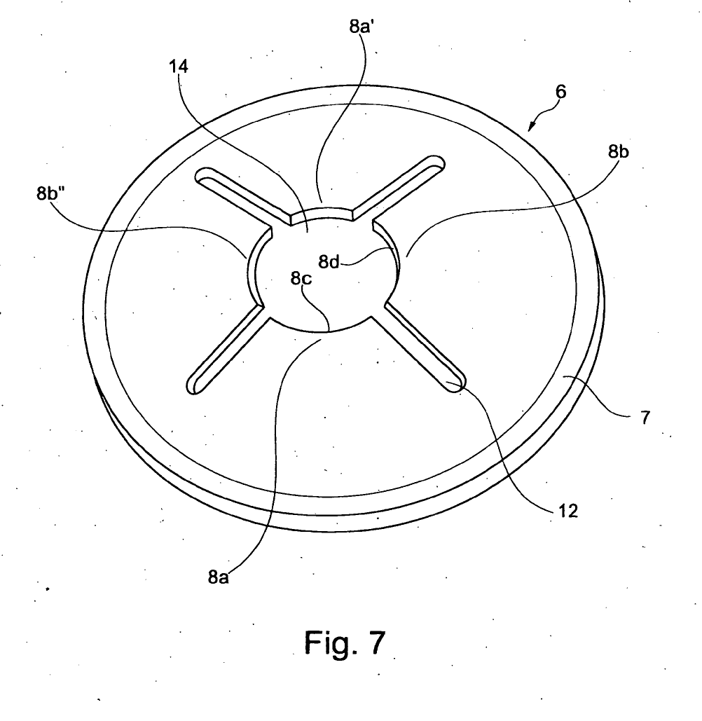

FIG. 6 shows an exemplary embodiment of a fastening claw having only two tongue-like elements 8a, 8b, the free ends of which are rounded concavely. The slots 12, which separate the two tongue-like elements 8a, 8b from one another, are designed in trapezoidal-like fashion here.

FIG. 7 shows an exemplary embodiment of a fastening claw 6 having four tongue-like elements 8a, 8b, 8a′, 8b′. Two back to back tongue-like elements 8a, 8b in circumferential direction are separated from one another by a respective narrow slot 12 that extends in the radial direction and is rounded out at its base. In this exemplary embodiment too, the free ends 8c, 8d of the tongue-like elements 8a, 8b are concavely rounded out.

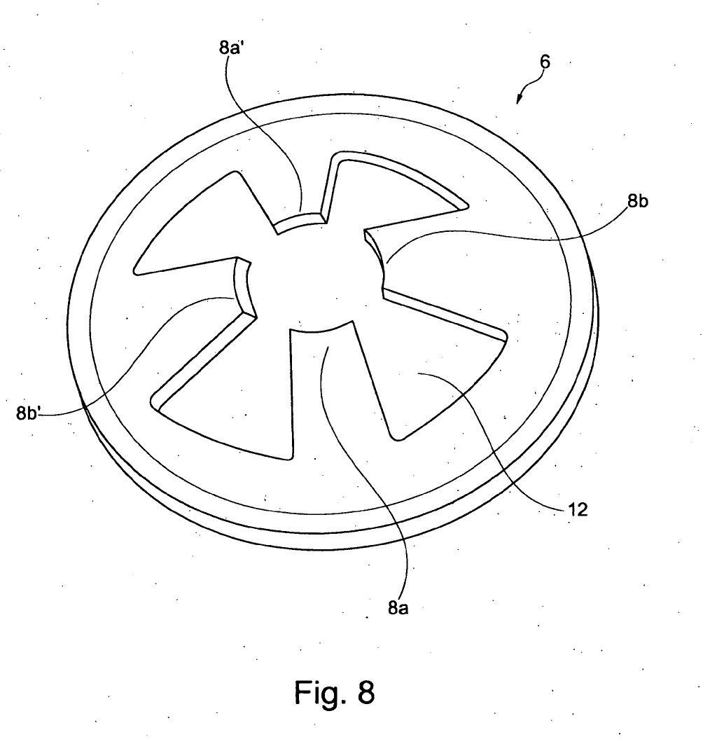

FIG. 8 shows an exemplary embodiment of a fastening claw 6 where also four tongue-like elements 8a, 8b, 8a′, 8b′ are provided. In contrast to the exemplary embodiment of FIG. 7, the slots are designed here similarly to the exemplary embodiment of FIG. 6 in a trapezoidal-like fashion.

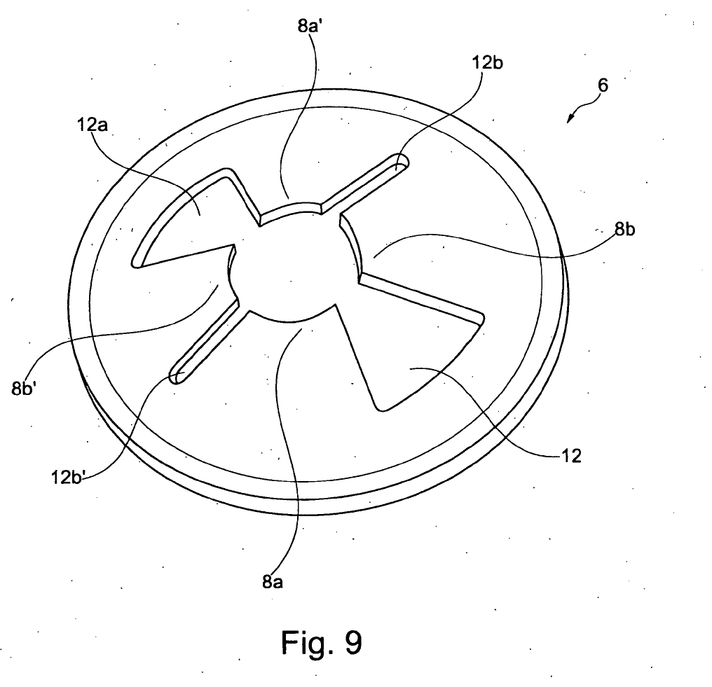

FIG. 9 shows an exemplary embodiment of a fastening claw 6 where four tongue-like elements 8a, 8b, 8a′, 8b′ are provided. The slot 12 that separates the two tongue-like elements 8a, 8b as well as the opposite slot 12a is developed trapezoidal-like, whereas the two other slots 12b, 12b′ are developed as relatively narrow, straight slots running in the radial direction.

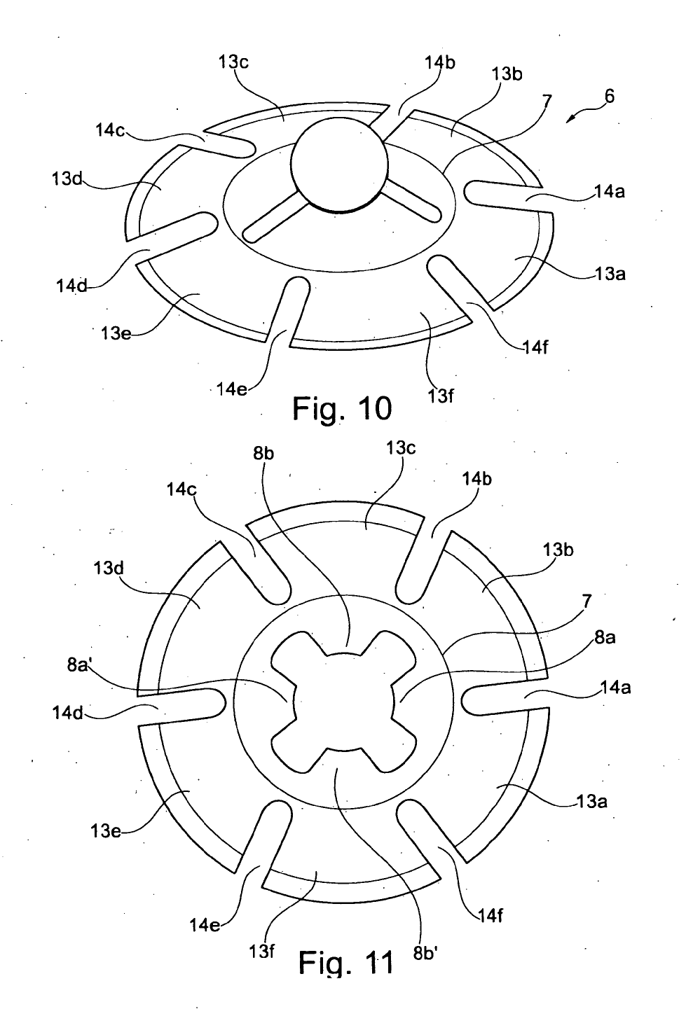

FIG. 10 shows an exemplary embodiment of a fastening claw 6 having a plurality of screen ring sections 13a, 13b, 13c, 13d, 13e, 13f arranged in circumferential direction of the annulus section 7 and extending radial obliquely outward from the same, wherein back to back screen ring sections in circumferential direction are each separated from the other by a screen ring slot 14a to 14f, which essentially extends in the radial direction. As already indicated, it may be provided that the screen ring sections 13a to 13f are not located in the same plane as the annulus section 7, but instead project obliquely downward from the same. The screen ring sections and the tongue-like elements and/or the entire fastening claw 6 have some flexibility.

FIG. 11 shows a similar exemplary embodiment, with screen ring sections 13a to 13f also projecting radially outward from the annulus section 7. A total of six screen ring sections 13a to 13f are provided, whereas only four tongue-like elements 8a, 8b, 8a′, 8b′ are provided.

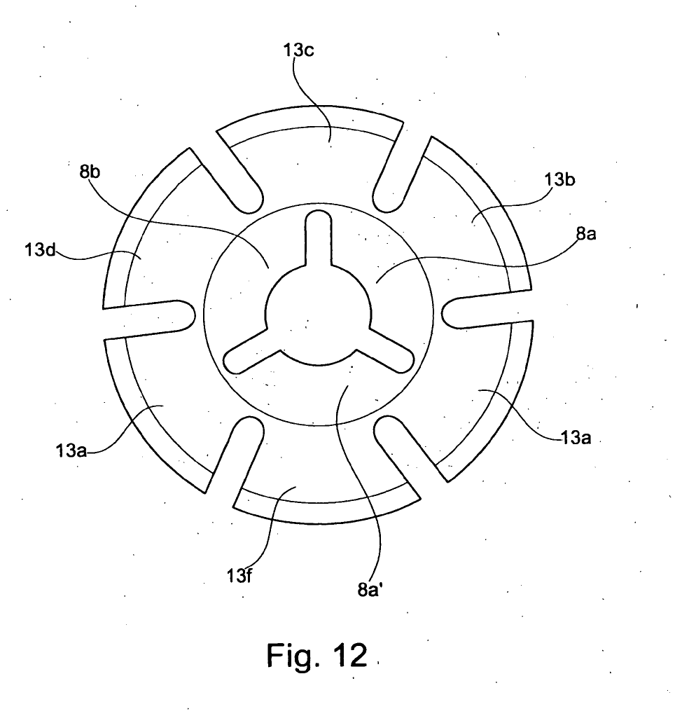

FIG. 12 shows an exemplary embodiment with six screen ring sections 13a to 13f being provided, but only three tongue-like elements 8a, 8b, 8a′.

For the sake of completeness, it should also be mentioned that the free ends 8c, 8d (see FIG. 7, for example) border or define a center open region 14 of the fastening claw 6, into which, for example, the male fixing element 2 shown in FIG. 5 can be inserted with its sphere 2a from an underside of the fastening claw 6 and clamped between the free ends of the tongue-like elements 8a, 8b, 8a′, 8b′.

FIG. 13 shows a schematic representation of the basic principle of the invention. The first component 1, which, for example, may be a (steel) sheet metal (such as a body part of an automotive body, for example), has an elevation la projecting slightly upward from the first component 1. In the case of a sheet metal part, the elevation la can also be developed as an outward pressing. The elevation la may be produced, for example, in a pressing or deep drawing tool by which the component 1 was formed. The elevation la forms a “connecting point” of the first component 1, onto which the male fixing element 2, which here is formed by a single sphere, is welded. The first component 1 can also be punched through in the region of the elevation la, which has the advantage that the sphere or the male fixing element 2 can also be welded to the first component from below.

As shown in FIG. 13, a transition region lb between the connecting point and the first component 1 is configured to enlarge conically downward.

Analogously to the previous exemplary embodiments, a second component 4 is placed on the first component 1. The second component 4 has a through-hole 5, the diameter of which is larger than the diameter of the male fixing element 2. The male fixing element 2 projects through the through-hole 5. Because of the elevation 1, in the exemplary embodiment shown in FIG. 13, this results in an “offset” of about 0.5 mm relative to the first component 1.

Analogously to the previous exemplary embodiments, the two components 1, 4 are clamped together by way of the male fixing element 2 and the fastening claw 6 clipped onto said male fixing element. The fastening claw 6, which is represented only schematically in FIG. 13, has an essentially planar annulus section 7, which bears on a top side of the second component 4, as well as flexible, tongue-like elements 8a, 8b, which bear obliquely from below on the male fixing element with their radial inner face sides, in a region below the equatorial plane 10.

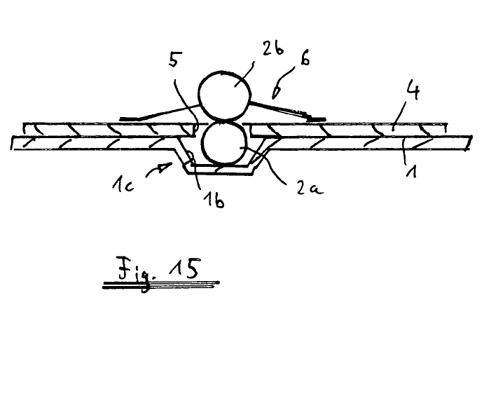

FIG. 14 shows a variant of the exemplary embodiment in FIG. 13. In contrast to FIG. 13, the elevation la here has a greater height of approx. 1.2 mm, which when using an identical sphere and an identical fastening claw 6 facilitates a clamping of a thicker, second component 4 on the first component 1.

FIG. 15 shows an exemplary embodiment where, instead of an elevation in the first component 1, a cavity-like depression or inward pressing 1c is provided. Thus, the connecting point is formed here by the inward pressing 1c. A “double sphere” male fixing element is welded onto the connecting point. Analogously to the exemplary embodiment of FIG. 1, the double sphere has a lower sphere 2a and an upper sphere 2b connected therewith, for example by welding. The “double sphere” intersperses a through-hole provided in the second component 4. The second component 4 is clamped by use of a fastening claw 6, which is supported at a top side of the second component 4 and the upper sphere 2b of the double sphere.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component connection, comprising:
a first component;
a male fixing element formed by at least one sphere, the male fixing element being connected to the first component at a connecting point of the first component and projecting from the first component;
a clip element clipped onto the male fixing element such that the clip element bears on the at least one sphere, wherein
the clip element bears obliquely from below on an outer surface of the at least one sphere in a region between a topside of the first component and an equatorial plane of the at least one sphere, and
the connecting point at which the male fixing element is connected to the first component is an elevation of the first component or a depression of the first component.

2. The component connection according to claim 1, wherein the elevation is an outward pressed portion of the first component or the depression is an inward pressed portion of the first component.

3. The component connection according to claim 1, wherein the at least one sphere of the male fixing element bears directly on the connecting point or is connected to the first component directly at the connecting point.

4. The component connection according to claim 1, wherein the male fixing element is made of metal or of steel.

5. The component connection according to claim 1, wherein the male fixing element is connected to the first component in a firm bond or by a weld.

6. The component connection according to claim 1, wherein the male fixing element has two or more than two interconnected spheres.

7. The component connection according to claim 1, wherein the clip element has a greater radial width than the elevation or depression forming the connecting point.

8. The component connection according to claim 1, wherein the first component is a deep drawn sheet metal component.

9. The component connection according to claim 1, wherein the elevation or depression is an elevation or depression produced by deep drawing or pressing.

10. The component connection according to claim 1, wherein the elevation or depression is connected via a conically developed transition region to a radial outer region of the first component connecting thereto.

11. The component connection according to claim 1, further comprising:
a second component having a through-hole, wherein
the male fixing element extends through the through-hole of the second component and projects with an equatorial plane of the at least one sphere over a top side of the second component that faces away from the first component.

12. The component connection according to claim 10, further comprising:
a second component having a through-hole, wherein
male fixing element extends through the through-hole of the second component and projects with an equatorial plane of the at least one sphere over a top side of the second component that faces away from the first component.

13. The component connection according to claim 12, wherein a radial inner edge of the through-hole bears on the transition region.

14. The component connection according to claim 1, wherein:
the clip element is a fastening claw having an annulus section with a radial inner side from which at least two flexible tongue elements project obliquely inward at the top in a direction of a topside of the fastening claw,
the tongue elements have free ends defining a center open region of the fastening claw, and
the male fixing element is introduced into the center open region from a lower side of the fastening claw and is clamped between the free ends of the tongue elements.

15. The component connection according to claim 14, wherein the tongue elements are separated by slots extending from the annulus section radially inward.

16. The component connection according to claim 15, wherein radial outer ends of the slots provided between the tongue elements are rounded out.

17. The component connection according to claim 14, wherein the tongue elements taper towards their free ends.

18. The component connection according to claim 17, wherein the free ends are rounded out.

19. The component connection according to claim 17, wherein the free ends are configured straight and extend tangentially relative to the center open region of the fastening claw.

20. The component connection according to claim 17, wherein the free ends are configured concavely so as to adapt to the male fixing element.

21. The component connection according to claim 14, wherein the tongue elements project from a plane formed by the annulus section at an angle that is in a range of 10° to 40°.

22. The component connection according to claim 21, wherein the angle is greater than 28°.

23. The component connection according to claim 14, wherein the tongue elements are arranged evenly distributed in circumferential direction of the annulus section.

24. The component connection according to claim 14, wherein the tongue elements are configured identically.

25. The component connection according to claim 14, wherein exactly two tongue elements are provided.

26. The component connection according to claim 14, wherein exactly three tongue elements are provided.

27. The component connection according to claim 14, wherein exactly four tongue elements are provided.

28. The component connection according to claim 14, wherein the fastening claw is made of metal or of steel.

29. The component connection according to claim 14, wherein the annulus section is planar.

30. The component connection according to claim 14, wherein a plurality of screen ring sections are arranged so as to be distributed over the circumference of the annulus section projecting radially outward from the annulus section.

31. The component connection according to claim 30, wherein two back to back screen ring sections in the direction of the circumference are each separated by a screen ring slot extending in a radial direction.

32. The component connection according to claim 31, wherein radial inner ends of the screen ring slots are rounded out.

33. The component connection according to claim 31, wherein the screen ring slots are offset in the direction of the circumference relative to the slots provided between the tongue elements.

34. The component connection according to claim 30, wherein the screen ring sections project obliquely downward from the annulus section.

35. The component connection according to claim 30, wherein the number of screen ring sections is equal to or greater than the number of tongue elements.

36. The component connection according to claim 14, wherein the fastening claw is punched from a sheet metal, and the tongue-like elements are bent open.

37. The component connection according to claim 14, wherein the fastening claw is case-hardened.

38. The component connection according to claim 14, wherein the fastening claw is coated with a coating material.

39. The component connection according to claim 14, wherein the fastening claw is coated with an anticorrosive coating.

40. The component connection according to claim 14, wherein the fastening claw is coated with an electrically insulating coating.

41. The component connection according to claim 14, wherein the fastening claw is made of plastic.

42. The component connection according to claim 14, wherein the fastening claw is a separate element and not an integral component of another component or another part.

43. The component connection according to claim 14, wherein the free ends of the tongue elements bear on the sphere obliquely from below on the outside in a region between a top side of the first component and an equatorial plane of the at least sphere.
